(19) United States
(12) Patent Application Publication
(10) Pub. No.: US 2007/0114260 A1
(43) Pub. Date: May 24, 2007

(54) Spring powered linear return mechanism

(76) Inventor: Michael V. Petrocelli, Batavia, OH (US)

Correspondence Address: JERROLD J. LITZINGER, 2134 MADISON ROAD, CINCINNATI, OH, 45208, US

(21) Appl. No.: 11/283,185

(22) Filed: Nov. 18, 2005

(51) Int. Cl. B25C 1/04

(52) U.S. Cl. 227/130

(57) ABSTRACT

A spring powered return mechanism for linear movement is disclosed. The mechanism is characterized by a novel spring design that allows for high linear speed and energy efficiency. The design features few parts that are simple to manufacture and assemble. In addition, the design allows variable return forces along the movement axis by modifying the spring geometry.

### BACKGROUND OF THE INVENTION

1. Field of the Invention

The present invention is directed in general to linear return mechanisms, and, in particular, to a novel spring design that allows simple construction with high linear speed capability and low energy loss. Application areas of the mechanism include power tools, office machines, and in general other linear acting devices.

2. Description of the Related Art

Existing linear return mechanisms fall into three basic categories: springs, and/or plastic members, gas/hydraulic, and rotary to linear conversion mechanisms.

Known spring return mechanisms consist of a coil spring configured in either a compression or tensile manner. As the body to be returned moves away from the starting point, the spring resists this movement. When the moving force is removed the spring returns the body to the starting point. The force exerted by the spring on the body is proportional to the distance moved according to the spring constant. This is energy lost to the system. In addition, the linear speed is limited by spring physics. For a high strength steel spring, the maximum velocity is around 35 feet per second (10 meters per second) for extended use. This speed limit is related to the material properties such as strength, rigidity and density. Light rigid materials such as titanium and beryllium allow substantially higher speed—as high as 100 feet per second (30 meters per second). However, the cost of titanium limits its use while the toxicity problems of beryllium are well known.

Devices of this type are taught in U.S. Pat. Nos. 2,585,942 and 4,544,090. U.S. Pat. No. 2,585,942 shows a fastener-applying device uses a helical spring located beneath the piston which returns the staple driving piston to its starting position after a fastener is driven. U.S. Pat No. 4,544,090 shows a driver return assembly for an electromechanical fastener driving tool which uses an elastomeric cord attached to the driver at one end and to an anchor at the other end. The cord passes about at least two pulleys to compensate for stretch in the cord to assure that the driver is returned to its normal, retracted position after each working stroke.

Another category of linear return mechanism uses either gas or liquid as commonly found in pneumatic or hydraulic cylinders. Here, the body moved is the piston with an attached mass via a connecting rod. The piston is propelled by the pressurized fluid and then returned by reversing the pressurized side of the piston using valve means. These systems require the availability of a source of pressurized fluid such as a pump or compressor and also valve and control means. Speeds for pneumatic systems are limited to around 35 feet per second (10 meters per second). Hydraulic system speeds are slower.

Devices of this type are taught in U.S. Pat. Nos. 3,040,709 and 3,622,062. U.S. Pat. No. 3,040,709 uses a volume of air entrapped in an air return chamber as the piston assembly drives a fastener to provide an upwardly directed force to return the piston and driver blade to its upper position. U.S. Pat. No. 3,622,062 uses the exterior portion of the driver blade to facilitate complete decompression of the air return chamber and an adjustable seal on the drive piston enabling a small amount of pressurized air to bleed past the piston head during the drive stroke to facilitate pressure buildup in the air return chamber and effect more rapid return of the drive piston to its firing position.

Another variation of return system uses a gas spring. The gas spring consists of an enclosed cylinder with gas pressurized at a few thousand psi. The spring force acts outwardly from the gas pressure acting on the area of the piston rod since the gas pressure is the same on both sides of the piston. The spring force can be nearly constant if a large gas reservoir and large valving means is provided, but without sufficient reservoir, the force will increase with movement. Speeds are limited by seal design at a maximum of 50 feet per second (15 meter/sec).

Yet another variation of a gas spring ironically relies on a vacuum on one side of a piston that is contained in a cylinder closed on one end wherein the vacuum (or partial vacuum) is formed as the piston is withdrawn. Here the force is atmospheric pressure (14.7 psi) acting on the piston diameter. Since the air reservoir is the atmosphere, there is no reservoir effect on the force; thus, the spring force remains constant with linear movement. Speeds are limited by seals and generally limited to 50 fps (15 meter/sec).

A device of this type is taught in U.S. Pat. No. 6,755,336. This patent shows a piston assembly slidably received within a cylinder wherein as the tool progresses through its power cycle, the piston assembly creates a vacuum which draws the piston assembly back towards the sealed end of the cylinder to reset the assembly to its starting position.

Another category of return mechanism uses rotary motion that is converted to linear lotion by a generally flexible member such as a chain, belt, or cable. A motor or a torsional spring may provide the rotary motion. In the case of motion provided by a spring, the return force increases with the linear movement, whereas a motor with control can provide a constant return force. Speed capability can be very high but the complexity for motor and control limits use.

A device of this type is taught in U.S. Pat. No. 5,320,270. This patent shows a tool having a conically shaped flywheel which cooperates with a drum to cause a driver coupled to the drum by a cable to be pulled through a working stroke. A torsion spring causes the drum to rotate in the opposite direction, unwinding the cable and forcing the driver to return to its normal unactuated position.

### SUMMARY OF THE PRESENT INVENTION

Consequently, a need exists for a spring powered return mechanism as a replacement for traditional coil spring, gas/hydraulic, or rotary conversion mechanisms.

It is an object of the present invention to provide a device having a high linear velocity capability.

It is further an object of the present invention to provide a device having a high-energy efficiency when compared with most existing mechanisms.

A still further object of the present invention is to provide a simple self-powered mechanism consisting of a few parts that are simple to manufacture.

These and other objects of the present invention will be more readily apparent from the description and drawings below.

### BRIEF DESCRIPTION OF THE DRAWINGS

The accompanying drawings, incorporated in and forming a part of the specification, illustrate several aspects of the present invention, and, together with the description, serve to explain the principles of the invention. In the drawings:

FIG. 1 is a sectional view of the present invention in the initial position;

FIG. 2 is a sectional view of the present invention in fully extended position;

FIG. 3 is a sketch illustrating the effect of ramp angle, geometry and friction;

FIG. 4 is a graph showing the relationship of ramp angle versus friction coefficient for a given design;

FIGS. 5A-D is a series of drawings illustrating alternative spring designs;

FIGS. 6A and B are drawings illustrating alternative embodiments;

FIG. 7 illustrates a design alternative on the guide rollers;

FIG. 7A is a sectional view from FIG. 7 along line 7A-7A;

FIG. 8 depicts means to retain contact between rollers and springs;

FIG. 8A is a sectional view from FIG. 8 along line 8A-8A;

FIG. 9 is a plan view, partly in cross section, of a guidance means for the present invention;

FIG. 10 is a plan view, partly in cross section, of an alternative guidance means for the present invention;

FIG. 11 is a sectional view taken along line 11-11 of FIG. 10; and

FIG. 12 is a fragmentary plan view of a fastener driving tool which includes the present invention.

### DETAILED DESCRIPTION OF THE PREFERRED EMBODIMENTS

Reference will now be made in detail to the present preferred embodiments of the invention, an example of which is illustrated in the accompanying drawings, wherein like numerals indicate the same elements throughout the views.

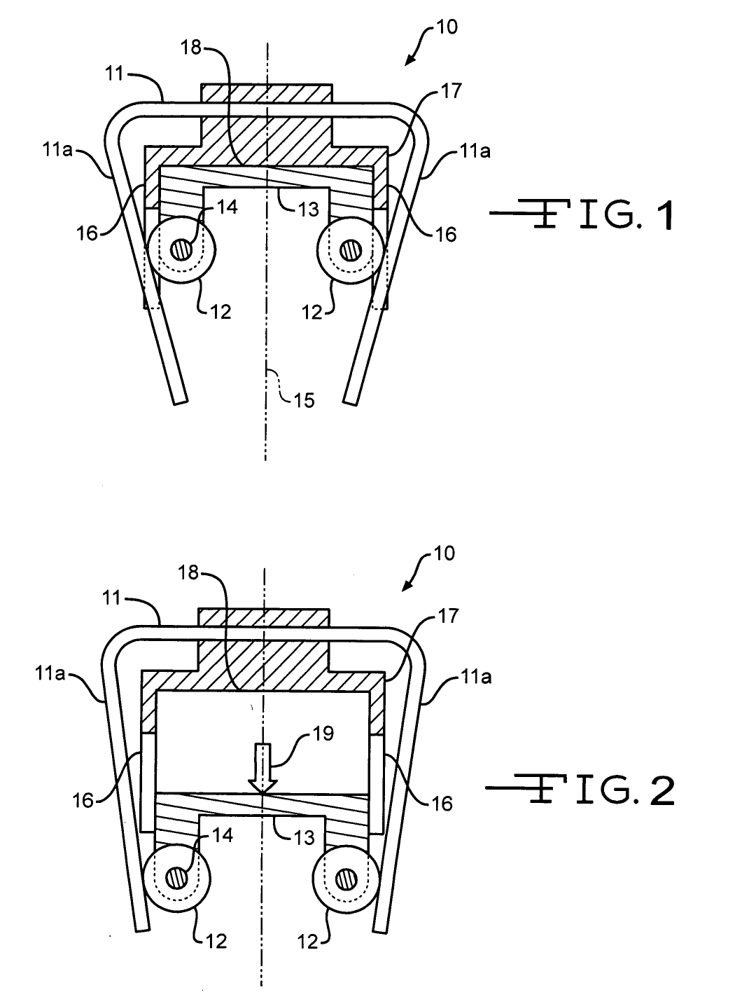

Referring now to the drawings, FIG. 1 is a sectional view of a mechanism employing the principles of the present invention. The mechanism, generally designated at 10, illustrates the invention in the initial (returned) position. The design includes torsional spring 11 having a pari of arms 11a engaged with rollers 12 mounted for rotation on a moving body 13 via pins 14. Body 13 is guided to move along a vertical axis 15 by a set of rails 16 depending from a frame 17. Spring arms 11a are preloaded inwardly on rollers 12 thus forcing the body upwardly against a lower surface 18 of frame 17.

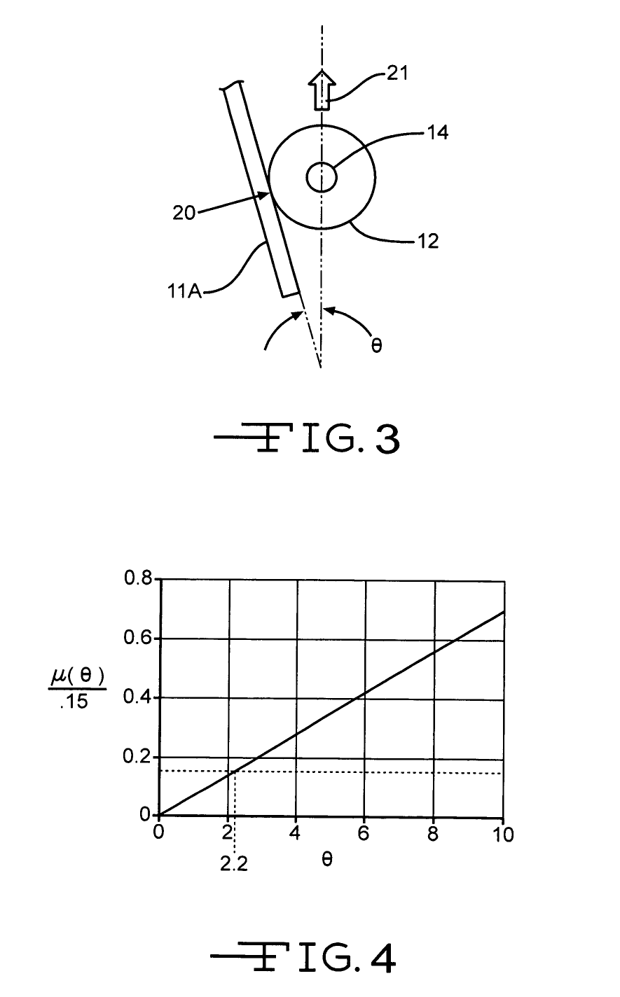

In FIG. 2, the mechanism 10 of FIG. 1 is shown in the fully activated or extended position. Body 13 has been propelled along axis 15 by a propulsion force 19 acting upon body 13. When propulsion force 19 is removed, body 13 is returned to the initial position by spring 11 acting on rollers 12.

In FIG. 3, a schematic shows the relationship of ramp angle Θ versus roller 12 diameter and pin 14 diameter. Spring arm 11a exerts force 20 on roller 12. If the ramp and friction values are favorable, the net roller force component overcomes the friction at pin 14. The ramp angle Θ is directly proportional to friction—with more friction, a larger ramp angle is needed to propel the body upwardly along in a direction 21.

FIG. 4 is a graph showing the relationship of ramp angle Θ versus friction coefficient μ. The relationship between the minimum ramp angle and friction is determined by the following equation:

$$μ ( Θ ) := \frac{D}{d } \cdot sin ( Θ \cdot deg )$$

where D is the roller diameter and d is the pin diameter.
For a given friction coefficient μ the ramp angle Θ be equal to or greater than the value shown on the graph in order for the body to be returned to its initial position. On the graph, a friction coefficient of 0.15 corresponds to a minimum angle of 2.2 degrees. In practice, a somewhat larger angle would be selected.

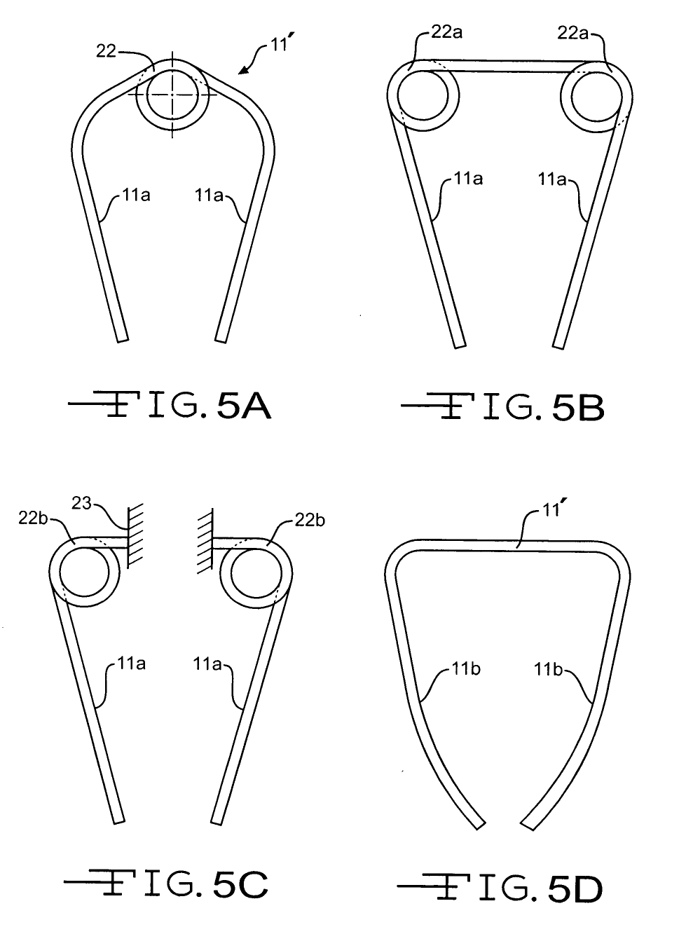

Alternative spring 11 designs are shown in FIGS. 5A-D. There are several design possibilities that can be deployed successfully. In FIG. 5A, a torsional spring 11′ with one or more concentric loops is illustrated. A pair of dual offset loops 22a are shown in FIG. 5B. Dual individual loops 22b are depicted in FIG. 5C, which loops are fixed on either side of a support 23. In FIG. 5D, the curvature of the spring arms 11b of spring 11′ is shown. By employing curvature, the ramp angle can be adjusted through the stroke of the mechanism and, thus, the return force can also be adjusted as desired. This approach can be used to minimize energy loss in the return mechanism.

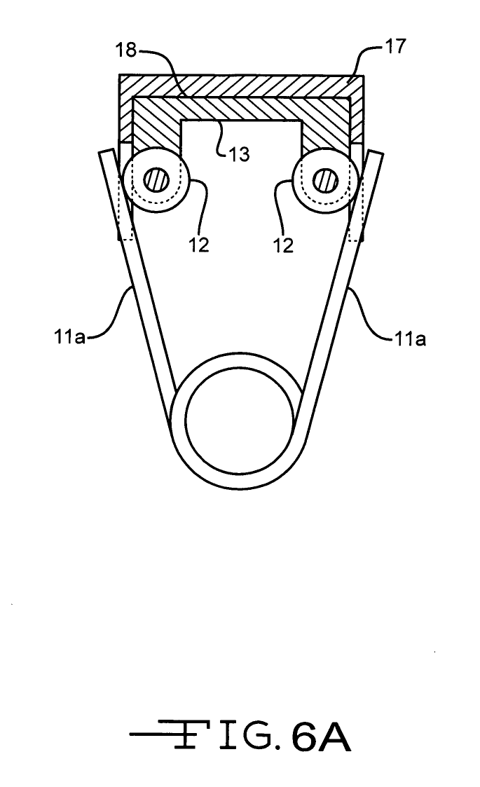

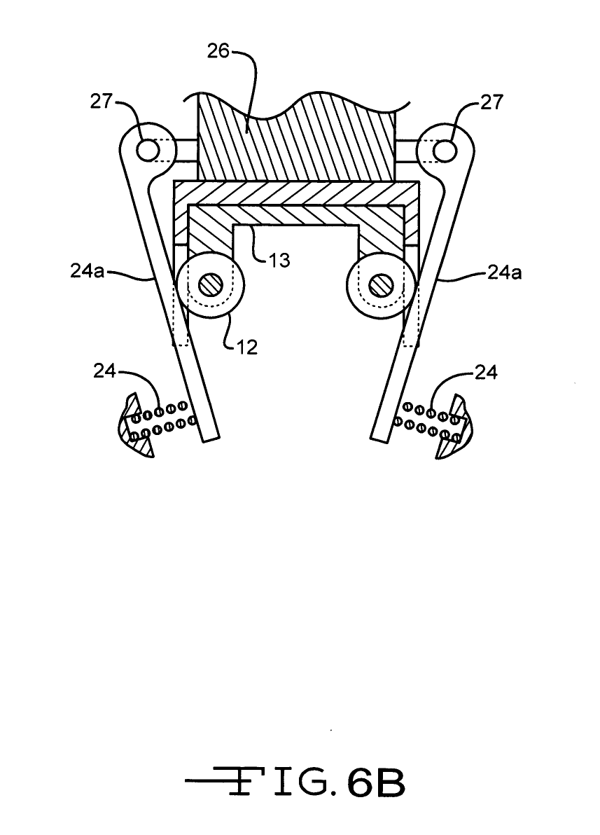

Alternative design arrangements are shown in FIGS. 6A-B. In FIG.6A, the spring 11 is shown in a lower position. The mechanism works in a similar manner- that is, spring arms 11a push against rollers 12 and force body 13 upwardly against surface 18 of frame 17.

In FIG. 6B, another alternative design arrangement is presented. In this embodiment, the torsional spring arms have been replaced by a set of compression springs 24 and corresponding pivoting links 24a, which are fixed for rotation on either side of a support 26 by a set of pins 27. The mechanism works similar to the previous embodiment in that springs 23 push inwardly on rollers 12 as links 24a pivot about pins 27. The resultant force moves body 13 in an upward direction. While compression springs 24 have been shown in this arrangement, clearly other types of springs can be readily adapted to the disclosed mechanism. The alternative spring designs include tensile, leaf, cantilever, and combinations of these spring designs.

The spring material can be metallic, plastic, or composite. The spring material must have rigidity, yet allow flexibility. In addition, durability is required for high-speed applications; for this reason, foraminous materials are unsuitable due their lack of toughness.

The cross section of the torsional springs may be circular, elliptical, or rectangular (including square). Since no orientation is required, the circular cross section eases manufacturing. However, since torsional springs have primarily bending stress, the circular cross section has high stress points at the outer edges. Meanwhile, a rectangular or square cross section distributes stresses more evenly across an edge. However, square or rectangular cross sections are more difficult to fabricate due to the need for orientation.

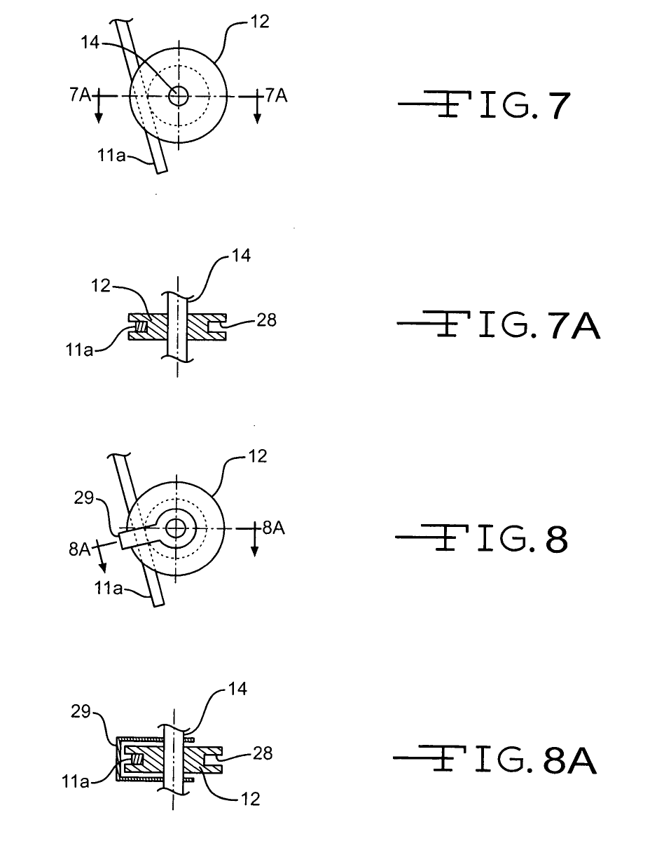

FIGS. 7 and 7A illustrate a means of guiding the spring arms 11a on roller 12. A groove 28 is provided within each roller 12 for accommodating spring arm 11a, thus guiding the arm. For a circular section of spring arm 11a, a similar semicircular groove on roller 12 would be provided.

FIGS. 8 and 8A depict means to keep spring arms 11a in contact with rollers 12A retaining member 29 is attached to shaft 14 of roller 12, thus entrapping spring arm 11a within groove 28 of roller 12. Again, a square section is depicted, but clearly a similar device could be designed for circular, elliptical or rectangular sections of spring arm 11a.

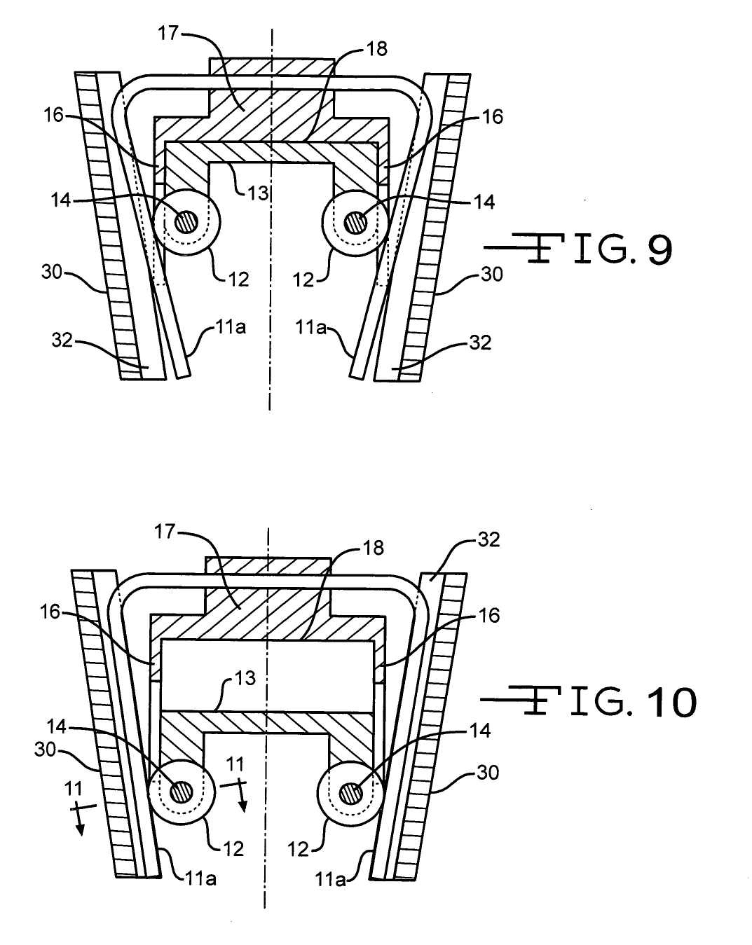

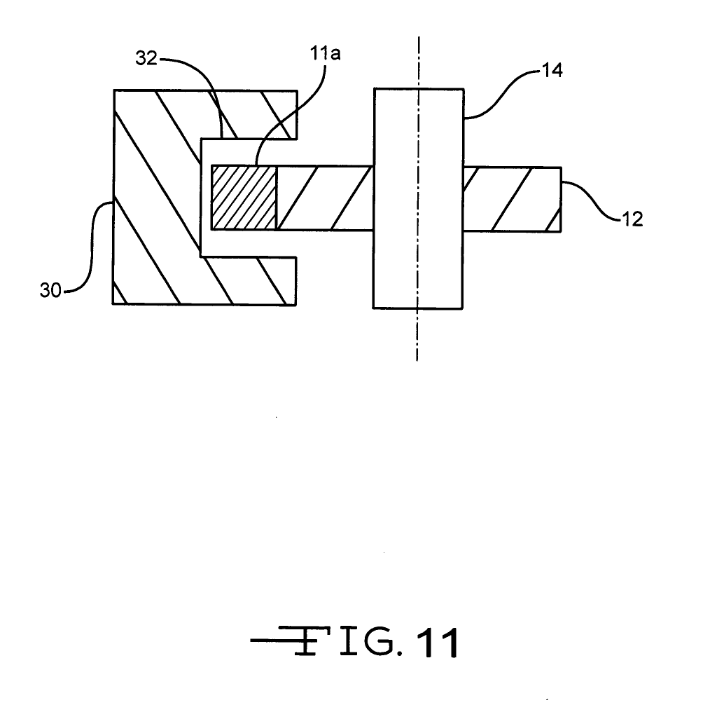

FIGS. 9, 10 and 11 show a design enhancement in restricting and guiding the movement of spring arms 11a. A pair of guide members 30 each having a cutaway portion 32, provide guidance to spring arms 11a and also limit their movement. Note that, to absorb impact of arms 11a, guide members 30 could be made of an elastomeric material.

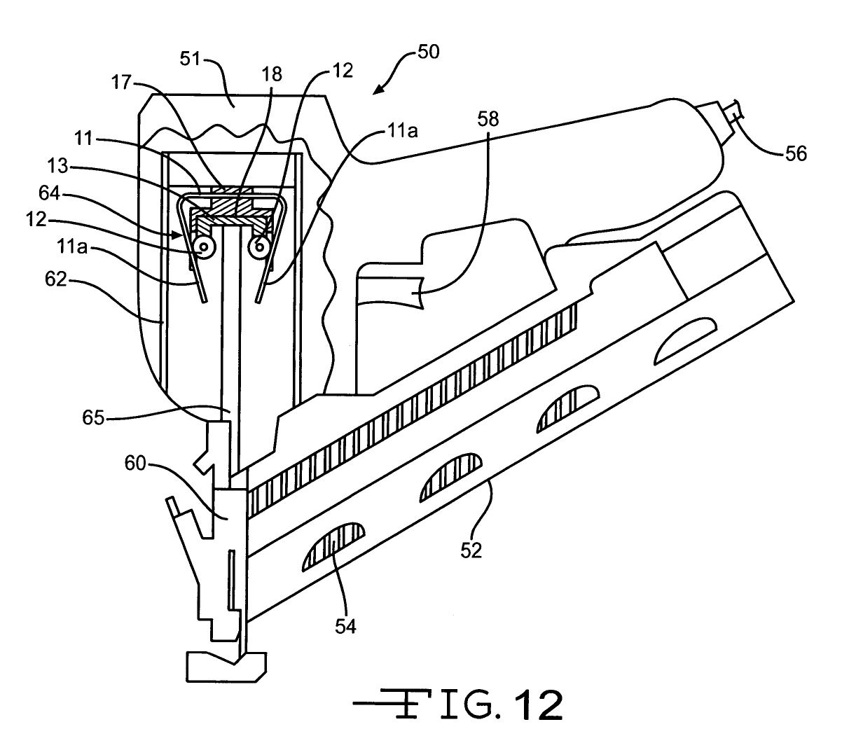

All the designs depicted in the figures utilize a pair of spring arms in a planar arrangement. However, designs have been envisioned that use 3, 4 or more spring arms in multiple planes. The number can be varied according to the requirements of the return system. A design with one spring arm is also feasible. FIG. 12 shows an exemplar fastener driving tool which is suitable for the use of the present invention for returning the drive piston. Referring now to FIG. 12, there is shown a fastener driving tool, generally designated at 50. Tool 50 is preferably of the type described in U.S. Pat. No. 6,830,173, which patent is assigned to the assignee of the present invention, and is incorporated by reference herein. Tool 50 contains a housing 51, a magazine 52 for containing a strip of fasteners 54, means 56 for connecting tool 50 to a suitable power source, and a trigger switch 58 for activating a firing cycle for tool 50. Tool 50 also contains a guide body 60 and a cylinder sleeve 62 within housing 51. A return assembly 64, similar to the mechanism 10 shown in FIG. 1, is positioned within sleeve 62, and a driver blade 65 is affixed to the bottom of assembly 64.

In operation, when trigger switch 58 is activated, moving body or piston 13 is propelled downwardly by force supplied by the power source, causing driver blade 65 to travel within cylinder sleeve 62 to strike a fastener from strip 54 witin magazine 52 in guide body 60, driving the fastener into a workpiece. When the cycle is completed, the force of spring arms 11a of spring 11 act in conjunction with rollers 12 to return piston 13 against lower surface 18 of frame 17.

In the above description, and in the claims which follow, the use of such words as “clockwise”, “counterclockwise”, “distal”, “proximal”, “forward”, “outward”, “rearward”, “vertical”, “horizontal”, and the like is in conjunction with the drawings for purposes of clarity. The foregoing description of the preferred embodiments of the invention has been presented for purposes of illustration and description. It is not intended to be exhaustive or limit the invention to the precise form disclosed, and many modifications and variations for the device are possible in light of the above teaching. The embodiment was chosen and described in order to best explain the principles of the invention and its practical application to thereby enable others skilled in the art to best utilize the invention and various embodiments and with various modifications as are suited to the particular use contemplated. It is intended that the scope of the invention be defined by the claims appended hereto.

What is claimed is:

1. A linear motion return mechanism, comprising:
a frame;
spring means, fixed relative to said frame, having one or more elastic arms which provide a force when shifted outwardly;
a movable body, shiftable within said frame between a first at rest position and a second activated position, having a pair of extensions located between said one or more arms of said spring means;
and a pair of rollers, each rotatably coupled at the end of a body extension, contacting said one or more arms of said spring means;
such that when said movable body is shifted from said first at rest position to said second activated position, said body is returned to said first at rest position by the force applied to said rollers by said spring means when said arms are shifted outwardly.

2. The mechanism of claim 1, wherein said spring means comprises a torsional spring.

3. The mechanism of claim 1, wherein said frame further comprises a pair of rails for guiding said movable body in a linear direction.

4. The mechanism of claim 1, wherein the cross section of said spring arms is circular.

5. The mechanism of claim 1, wherein the cross section of said spring arms is rectangular.

6. The mechanism of claim 1, wherein said rollers each contain a groove for guiding said spring arm.

7. The mechanism of claim 6, further comprising a retaining member enclosing said groove of each roller to contain said spring arm within said groove.

8. The mechanism of claim 1, wherein said spring means comprises a torsional spring having a concentric loop connecting said first and second arms.

9. The mechanism of claim 8, wherein said spring means comprises a first concentric loop coupled to said first arm, a second concentric loop coupled to said second arm, and a linear section coupling said first and second concentric loops.

10. The mechanism of claim 1, further comprising a first compression spring coupled to said first arm and a second compression spring coupled to said second arm wherein said first and second compression springs bias said first and second arms toward one another.

11. The mechanism of claim 1, further comprising guide means, affixed relative to said frame, having a first channel for limiting the outward travel of said first arm and a second channel for limiting the outward travel of said second arm.

12. The mechanism of claim 1, wherein said spring means is affixed to said frame.

13. The mechanism of claim 1, wherein said first and second arms of said spring means are angled toward one another.

14. The mechanism of claim 13, wherein said first and second arms comprise linear arms.

15. The mechanism of claim 13, wherein said first and second arms comprise curvilinear arms.

16. A return mechanism for use in a fastener driving tool of the type having a body, a fastener containing magazine affixed to said body, a trigger for actuating a drive cycle in said tool, a cylinder within said tool and an assembly located within said cylinder movable between an actuated position and a fastener driving position, said mechanism comprising:
a frame affixed within the cylinder;
spring means, affixed to said frame, having a pair of downwardly depending elastic arms which provide a force when shifted outwardly;
a piston, movable within said frame between an unactuated position and an actuated fastener driving position, having a pair of extensions located between said arms of said spring means;
a pair of rollers, each rotatably coupled to the end of a piston extension and contacting an arm of said spring means;
and a driver blade, affixed to said piston between said extensions, for driving a fastener from said magazine;
such that when said trigger is actuated, said piston and driver shift from said unactuated position to said fastener driving position to drive a fastener from said magazine, said piston and driver are returned to said unactuated position by the force applied to said rollers by said spring means when said arms are shifted outwardly.

17. The mechanism of claim 16, wherein said spring means comprises a torsional spring.

18. The mechanism of claim 16, wherein said frame further comprises a pair of rails for guiding said piston in a linear direction.

19. The mechanism of claim 16, wherein said pair of downwardly depending arms are angled inwardly.
